(19) United States
(12) Patent Application Publication
(10) Pub. No.: US 2013/0136370 A1
(43) Pub. Date: May 30, 2013

(54) METHOD FOR DESCRIBING CHARACTERISTICS OF DRAWN OBJECTS BY A TEXT STRING

(71) Applicants: Chun-Chia Tai, Hsinchu County (TW); Chih-Chun Huang, Hsinchu City (TW)

(72) Inventors: Chun-Chia Tai, Hsinchu County (TW); Chih-Chun Huang, Hsinchu City (TW)

(21) Appl. No.: 13/418,338

(22) Filed: Mar. 12, 2012

(30) Foreign Application Priority Data
Nov. 29, 2011 (TW) 100143703

(51) Int. Cl. G06K 9/62; G06F 17/00; H04W 4/12

(52) U.S. Cl. 382/224; 455/466; 235/375

(57) ABSTRACT

A method for describing characteristics of drawn objects by a text string includes drawing at least one object on a first display area of a first electronic device; the first electronic device generating a text string according to a type of the at least one object and a position of the at least one object shown on the first display area, the text string including a description text of the at least one object, the description text of the at least one object including a code of the at least one object and coordinates of the at least one object; the first electronic device transmitting the text string to a second electronic device; and the second electronic device displaying the at least one object on a second display area of the second electronic device according to the text string.

### BACKGROUND OF THE INVENTION

1. Field of the Invention

The present invention relates to a method for describing characteristics of drawn objects by a text string, and more particularly, to a method for describing characteristics of drawn objects by a text string and for re-drawing the objects according to the text string between electronic devices.

2. Description of the Prior Art

As related technology keeps improving, various types of handheld electronic devices are capable of executing more powerful functions. For example, a user can utilize a handheld electronic device to surf the Internet, to open application software, to execute a map navigation program, etc. However, the user normally can only utilize the handheld electronic device to make a phone call or transmit a short message for communicating with another user. When a first user is trying to communicate with a second user by drawing, the first user must draw a picture with characteristics of objects on a display area of the handheld electronic device by drawing software, and then the drawn picture is stored as an image file for being transmitted to a handheld electronic device of the second user. For example, when the first user is trying to inform the second user of a location of the first user on a map, the first user must first open the map software and store a map of a specific area as an image file, then the user opens the drawing software to edit the image file, such as adding a graphic object and a text on the image for marking the location of the first user. After the image file is edited, the edited image file is stored as anew image file for being transmitted to the handheld electronic device of the second user. Finally, the second user can utilize his handheld electronic device to open the new image file transmitted from the first user, in order to obtain location information of the first user.

However, the above processes are very complicated and inconvenient to the user. Moreover, a size of an image file is usually larger than sizes of other types of files, such that it is time-consuming to transmit the image file, and the user may be charged more for data transmission.

### SUMMARY OF THE INVENTION

The present invention provides a method for describing characteristics of drawn objects by a text string, the method comprises drawing at least one object on a first display area of a first electronic device; the first electronic device generating a text string according to a type of the at least one object and a position of the at least one object shown on the first display area, the text string comprising a description text of the at least one object, the description text of the at least one object comprising a code of the at least one object and coordinates of the at least one object; the first electronic device transmitting the text string to a second electronic device; and the second electronic device displaying the at least one object on a second display area of the second electronic device according to the text string.

In contrast to the prior art, processes of the method of the present invention are simple and convenient to the user. Moreover, the method of the present invention is capable of converting the drawn objects to the text string or barcode for being transmitted, such that it is time-saving and cost-saving for data transmission.

The present invention can be utilized for exchanging coordinate information, especially for exchanging geographical information. For example, The geographical information can be described as a text string or a barcode for being transmitted by a short message service, or HTTP GET/POST method, and then the geographical information can be duplicated according to the text string or barcode, in order to display the original described geographical information.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram showing a first embodiment of a first user drawing a plurality of objects on a first display area of a first electronic device.

FIG. 2 is a diagram showing the first user utilizing the first electronic device transmitting a text string to a second electronic device of a second user.

FIG. 3 is a diagram showing a second embodiment of the first user drawing a plurality of objects on the first display area of the first electronic device.

FIG. 4 is a diagram showing the first user drawing a 3D object on the first display area of the first electronic device.

FIG. 5 is a diagram showing a first embodiment of the first user drawing a plurality of objects on map software.

FIG. 6 is a diagram showing a second embodiment of the first user drawing a plurality of objects on map software.

FIG. 7 is a flowchart showing the method for describing characteristics of drawn objects by the text string.

### DETAILED DESCRIPTION

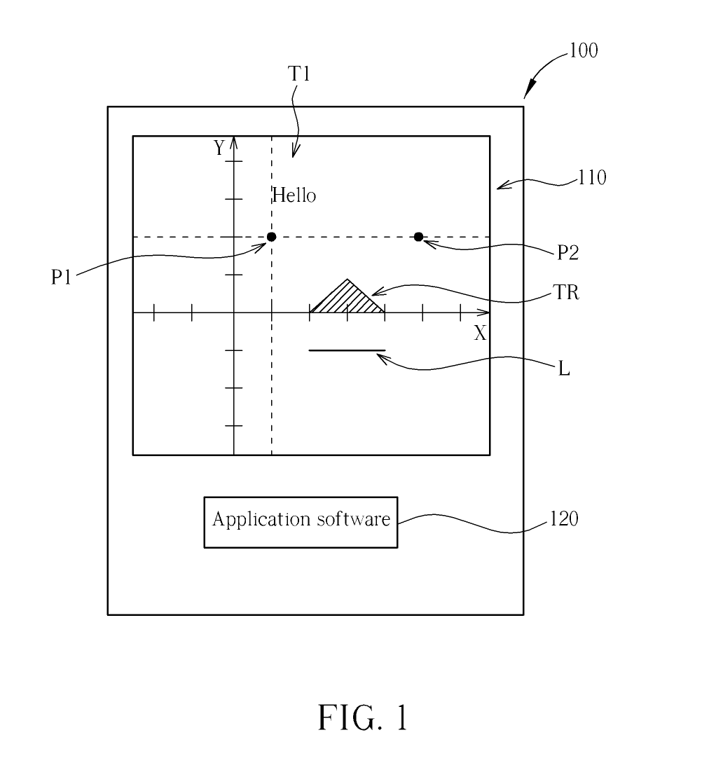

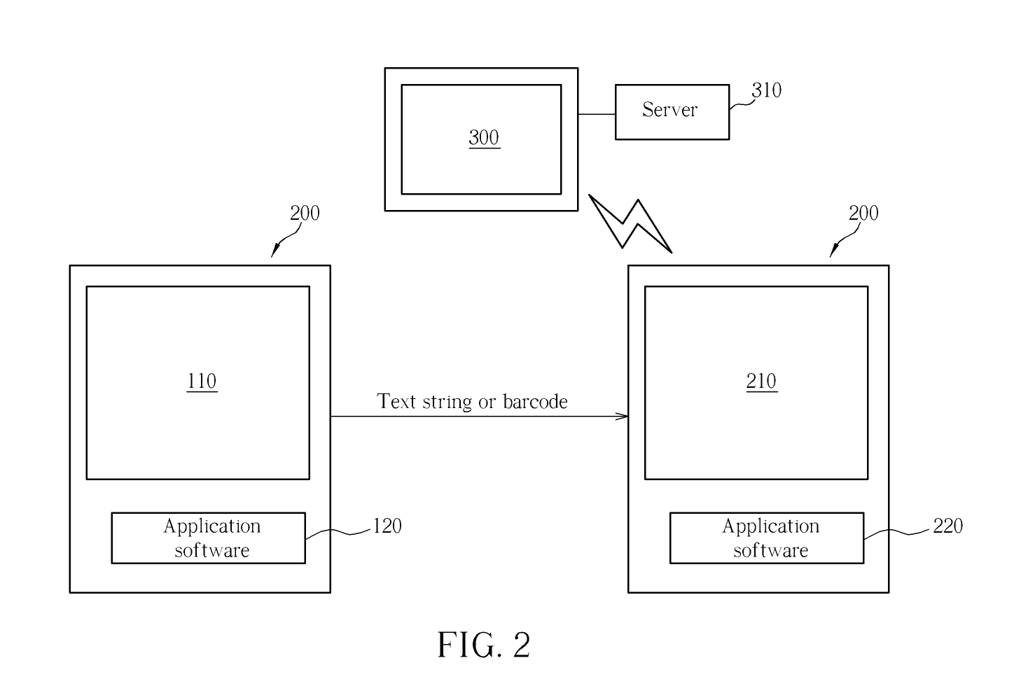

Please refer to FIG. 1 and FIG. 2. FIG. 1 is a diagram showing a first embodiment of a first user drawing a plurality of objects on a first display area 110 of a first electronic device 100. FIG. 2 is a diagram showing the first user utilizing the first electronic device 100 to transmit a text string to a second electronic device 200 of a second user. As shown in FIG. 1, the first user utilizes application software 120 to draw objects on the first display area 110 of the first electronic device 100, such as two points P1 and P2, a triangle plane TR, a horizontal straight line L, and a text T1. The application software 120 can be drawing software constructed by Javascript and HTML5 Canvas. For example, the first display area 110 can display the drawing software constructed by HTML5 Canvas or other similar programs. When the first user utilizes the application software 120 to draw objects on the first display area 110 of the first electronic device 100, the application software 120 can generate a text string according to types of the objects and positions of the objects shown on the first display area 110. The text string comprises a coordinate of a reference point on the first display area 110 and a description text of the objects. The description text of the objects comprises a code of each object and coordinates of each object corresponding to the reference point. For example, according to characteristics of the drawn objects of FIG. 1, the application software 120 can generate a text string as follows:

co=1,2&p1=0,0&p2=4,0&l1=1,−3,3,−3&tr1=1,−2,2,−1,3,−2&t1=0,1,Hello

where “co” is a code representing the reference point (intersection of dot lines); “1,2” represents an X-coordinate of the reference point is 1, and a Y-coordinate of the reference point is 2; “p1” is a code representing a first point P1; “0,0” represents relative XY-coordinates of the first point P1 corresponding to the reference point; “p2” is a code representing a second point P2; “4,0” represents relative XY-coordinates of the second point P2 corresponding to the reference point; “l1” is a code representing a straight line L; “1,−3” represents relative XY-coordinates of a start point of the straight line L corresponding to the reference point; “3,−3” represents relative XY-coordinates of an end point of the straight line L corresponding to the reference point; “tr1” is a code representing a triangle plane TR; “1,−2”, “2,−1” and “3,−2” respectively represent relative XY-coordinates of vertexes of the triangle plane TR corresponding to the reference point; “t1” is a code representing a text T1; “0,1” represents relative XY-coordinates of the text T1 corresponding to the reference point; “Hello” is description wording of the text T1; and “&” is for separating information of each object.

After the application software 120 generates the text string, the first electronic device 100 can further transmit the text string to a second electronic device 200 by a short message service (SMS) directly. Application software 220 of the second electronic device 200 then re-draws the objects, which are drawn on the first electronic device 100, on a second display area 210 according to the received text string. Or, the first electronic device 100 can generate a corresponding barcode (1D or 2D barcode) according to the text string, and then transmit the corresponding barcode to the second electronic device 200 by a multimedia messaging service (MMS). After the second electronic device 200 decodes the barcode to the original text string, the application software 220 of the second electronic device 200 then re-draws the objects, which are drawn on the first electronic device 100, on the second display area 210 according to the text string. According to the above arrangement, since a size of the text string or the barcode is much smaller than a size of an image file, data transmission thereof is faster and cheaper.

In addition, the text string can be embedded into an Internet address of a webpage, for example, an Internet address with the embedded text string can be expressed as follows:

http://aa.bb.cc/dd.php?co=1,2&p1=0,0&p2=4,0&l1=1,−3,3,−3&tr1=1,−
2,2,−1,3,−2&t1=0,1,Hello

Such that the second electronic device 200 can browse a web page 300 according to the Internet address “http://aa.bb.cc/dd.php”, and a server 310 executing a dd.php program draws the objects on the HTML5 Canvas of the webpage 300 according to the text string. Therefore, the second electronic device 200 can duplicate the drawn objects of the first electronic device 100 on a webpage browser of the second electronic device 200 by browsing the webpage 300.

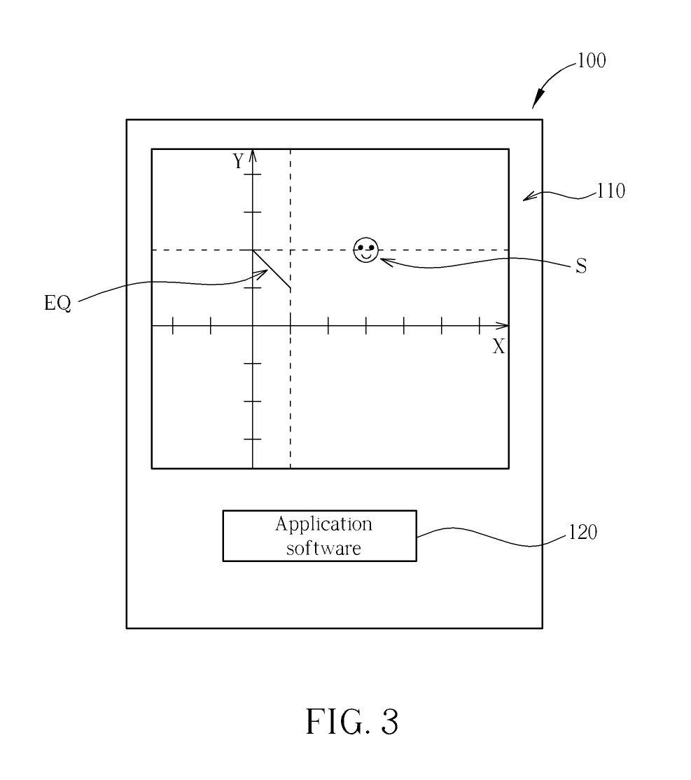

Please refer to FIG. 3. FIG. 3 is a diagram showing a second embodiment of the first user drawing a plurality of objects on the first display area 110 of the first electronic device 100. As shown in FIG. 3, the first user can also utilize the application software 120 to draw other objects on the first display area 110 of the first electronic device 100, such as an equation object EQ and a smiling-face symbol S. According to characteristics of the drawn objects of FIG. 3, the application software 120 can generate a text string as follows:

co=1,2&s1=2,0,1&eq1=x%2By=2,x=0-1,x%3E0,y%3E0

where “co” is the code representing the reference point (intersection of dot lines); “1,2” represents an X-coordinate of the reference point is 1, and a Y-coordinate of the reference point is 2; “s1” is a code representing the symbol S; “2,0,1” represents relative XY-coordinates of the symbol S corresponding to the reference point are (2,0), and the symbol S number “1” is a smiling-face symbol (a predetermined number corresponding to a predetermined symbol); “eq1” is a code representing the equation EQ; “x%2By=2” is a URL-encoded text representing “x+y=2”; “x=0-1” represents x is from 0 to 1; “x%3E0” is URL-encoded text representing “x>0”; and “y%3E0” is URL-encoded text representing “y>0”. The above description text of the equation EQ is shown as an oblique line in FIG. 3.

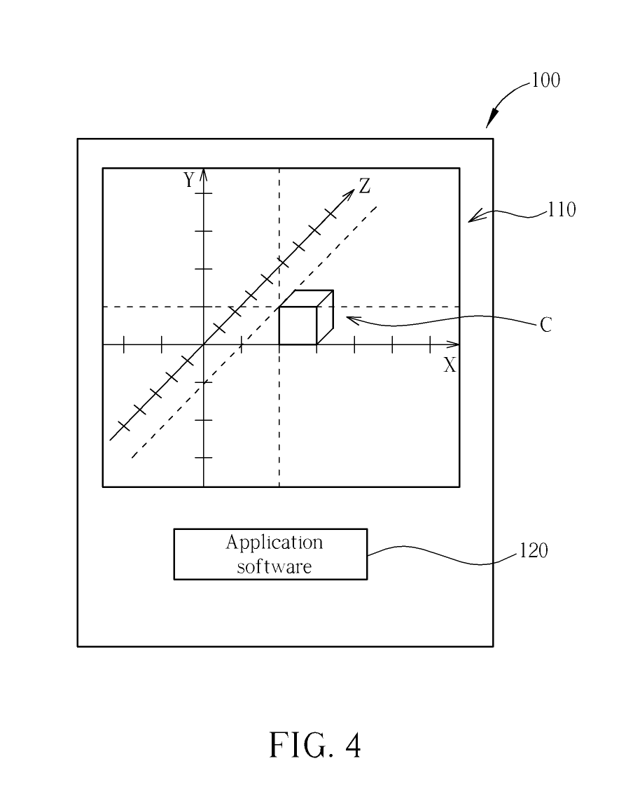

Please refer to FIG. 4. FIG. 4 is a diagram showing the first user drawing a 3D object on the first display area 110 of the first electronic device 100. As shown in FIG. 4, the first user can also utilize the application software 120 to draw a 3D object on the first display area 110 of the first electronic device 100, such as a cube C. According to characteristics of the drawn object of FIG. 4, the application software 120 can generate a text string as follows:

co=2,1,0&b11=0,0,0,1,−1,1

where “co” is the code representing the reference point (intersection of dot lines); “2, 1, 0” represents an X-coordinate of the reference point is 2, a Y-coordinate of the reference point is 1, and a Z-coordinate of the reference point is 0; “b11” is a code representing the cube C; “0, 0, 0” represents relative XYZ-coordinates of a first vertex of the cube C corresponding to the reference point; and “1, −1, 1” represents relative extended distances of XYZ-coordinates of the cube C opposite to the first vertex corresponding to the reference point.

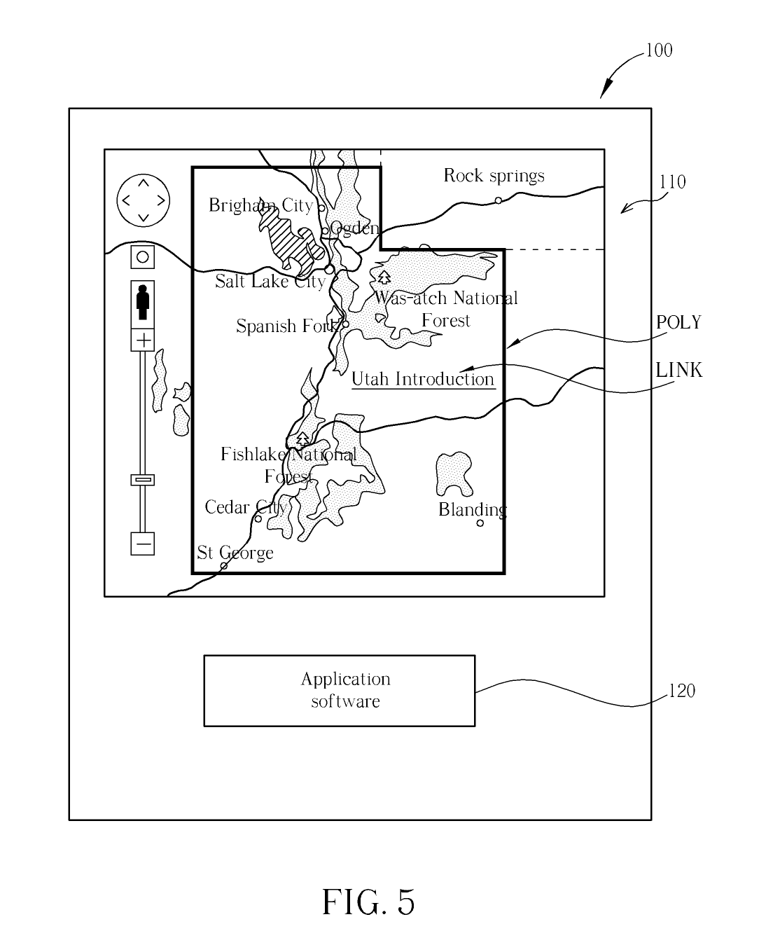

Please refer to FIG. 5, and refer to FIG. 2 as well. FIG. 5 is a diagram showing a first embodiment of the first user drawing a plurality of objects on map software. Besides drawing objects, the application software 120 of the first electronic device 100 can also call an application programming interface (API) of map software, and display a map of a specific area on the first display area 110 for allowing the first user to draw objects on the map by the application software 120. For example, as shown in FIG. 5, the application software 120 can call an API of Google Maps to display a map of Utah State of the United States on the first display area 110. The first user then utilizes the application software 120 to draw a polygon POLY and attach a webpage link LINK. According to characteristics of the drawn objects of FIG. 5, the application software 120 can generate a text string as follows:

co=37.001456,−114.052048&poly1=0,0,4.992746,0.010987,4.99989,3.0
04761,3.997101,3.004761,4.00021,5.001526,0,5.001526&u1=2.366823,
2.451096,http%3A%2F%2Fen.wikipedia.org%2Fwiki%2FUtah,Utah+Introd
uction

where “co” is the code representing the reference point; “37.001456,−114.052048” represents geographical coordinates of the reference point on the map; “polyl” is a code representing the polygon POLY; “0,0” represents relative latitude and longitude of a first vertex of the polygon POLY corresponding to the reference point; “4.992746,0.010987” represents relative latitude and longitude of a second vertex of the polygon POLY corresponding to the reference point; “4.99989,3.004761” represents relative latitude and longitude of a third vertex of the polygon POLY corresponding to the reference point; “3.997101,3.004761” represents relative latitude and longitude of a fourth vertex of the polygon POLY corresponding to the reference point; “4.00021,5.001526” represents relative latitude and longitude of a fifth vertex of the polygon POLY corresponding to the reference point; “0,5.001526” represents relative latitude and longitude of a sixth vertex of the polygon POLY corresponding to the reference point; “u1” is a code representing the webpage link LINK; “2.366823,2.451096” represents relative latitude and longitude of the webpage link LINK corresponding to the reference point; “http%3A%2F%2Fen.wikipedia.org%2Fwiki%2FUtah” is URL-encoded text representing an Internet address “http://en.wikipedia.org/wiki/Utah” of the webpage link LINK; and “Utah+Introduction” is URL-encoded text representing “Utah Introduction” for being displayed on the map as an anchor text of the webpage link LINK.

When the second electronic device 200 receives the above text string, the application software 220 of the second electronic device 200 calls the API of Google Maps to display the map and draws the objects shown in FIG. 5. If the second user clicks the webpage link LINK, a webpage browser of the second electronic device 200 opens a webpage indicated by the webpage link LINK “http://en.wikipedia.org/wiki/Utah”, which is a wiki webpage providing an introduction of Utah State of the United States.

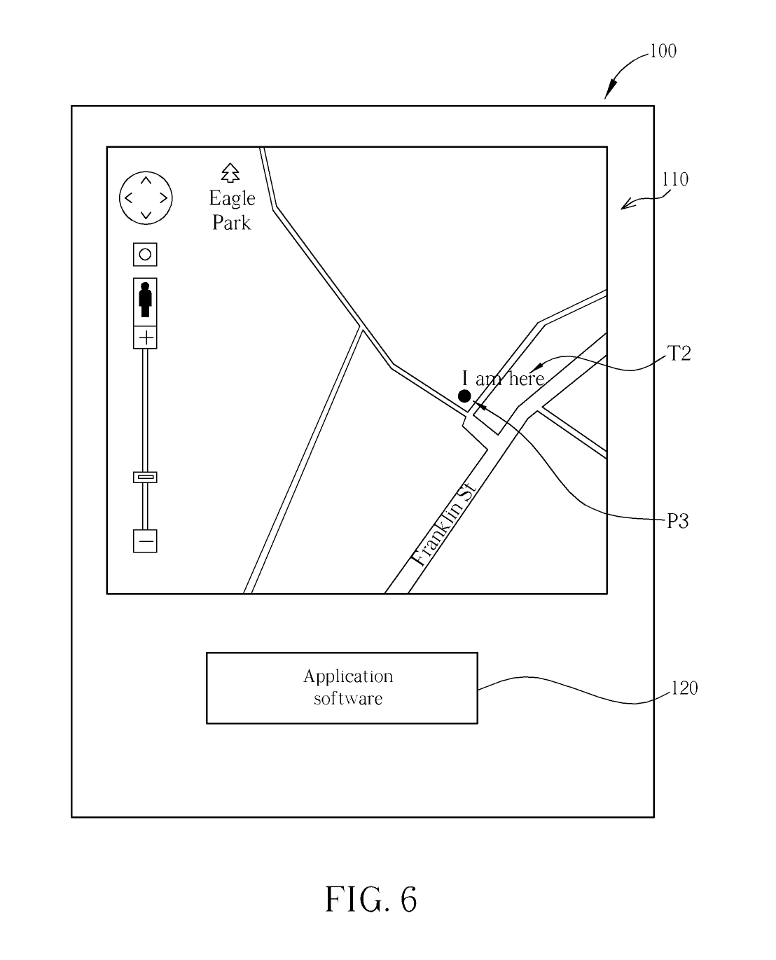

Please refer to FIG. 6, and refer to FIG. 2 as well. FIG. 6 is a diagram showing a second embodiment of the first user drawing a plurality of objects on map software. As shown in FIG. 6, when the first user is trying to notify the second user of a location of the first user on a map, the application software 120 of the first electronic device 100 can call the API of Google Maps to display a map corresponding to the location of the first user on the first display area 110. The first user then utilizes the application software 120 to mark a point P3 and attach a text T2 for indicating his location. According to characteristics of the drawn objects of FIG. 6, the application software 120 can generate a text string as follows:

co=37.388683,−122.085722&p1=0,0&t1=0.000041,0,I+am+here

where “co” is the code representing the reference point; “37.388683,−122.085722” represents geographical coordinates of the reference point on the map; “p1” is a code representing the point P3; “0,0” represents relative latitude and longitude of the point P3 corresponding to the reference point; “t1” is a code representing the text T2; “0.000041,0” represents relative latitude and longitude of the text T2 corresponding to the reference point; and “I+am+here” is URL-encoded text representing “I am here”. Thus, when the second electronic device 200 of the second user receives the text string, the application software 220 of the second electronic device 200 can open the map for showing the location of the first user.

Similarly, the text string can further comprise an Internet address as follows:

http://aa.bb.cc/dd.php?co=37.388683,−122.085722&p1=0,0&t1=0.0000
41,0,I+am+here

Such that the second electronic device 200 can browse the web page 300 according to the Internet address “http://aa.bb.cc/dd.php”, and the server 310 executing the dd.php program calls the API of Google Maps to draw the objects on the webpage 300 according to the text string. Therefore, the second electronic device 200 can duplicate the drawn objects of the first electronic device 100 shown in FIG. 6 by browsing the webpage 300.

In addition, when the first user transmits the text string to the second user by the short message service, the text string can further comprise a code “geo:” for notifying the receiving side that the short message of the text string comprises the geographical information and the text-describing objects. The above text string can be expressed as follows:

geo:co=37.388683,−122.085722&p1=0,0&t1=0.000041,0,I+am+here

Therefore, the application software 220 of the second electronic device 200 can determine the short message of the text string comprising geographical information and text-describing objects according to the code “geo:”, such that the application software 220 can further open the map for showing the location of the first user, that is, duplicating the drawn objects of the first electronic device 100 shown in FIG. 6 on the second display area 210. Moreover, in order to reduce characters of the text string, the above text string can be simplified as follows:

geo:37.388683,−122.085722&p1=0,0&t1=0.000041,0,I+am+here

where the code “co=” is deleted to let the geographical coordinates of the reference point follow behind the code “geo:” in order to reserve the space for other content.

In the above embodiments, the text strings described above are for illustrating how to describe characteristics of objects, and the format of the text string of the present invention is not limited to the above format. The codes of the objects are mentioned as examples, and the codes of the objects can be defined according to design requirements. The code of the object can represent a point, a line, a polygon, a plane, a 3D object, a text, an Internet address, a uniform resource identifier (URI), a symbol, an equation, or other types of objects capable of being drawn by drawing software.

In the above embodiments, the coordinates of the objects are relative coordinates corresponding to the reference point. But in other embodiments of the present invention, the coordinates of the objects can be absolute coordinates. In addition, it is not necessary for the information of the reference point to be comprised in the text string when the coordinates of the objects are absolute coordinates.

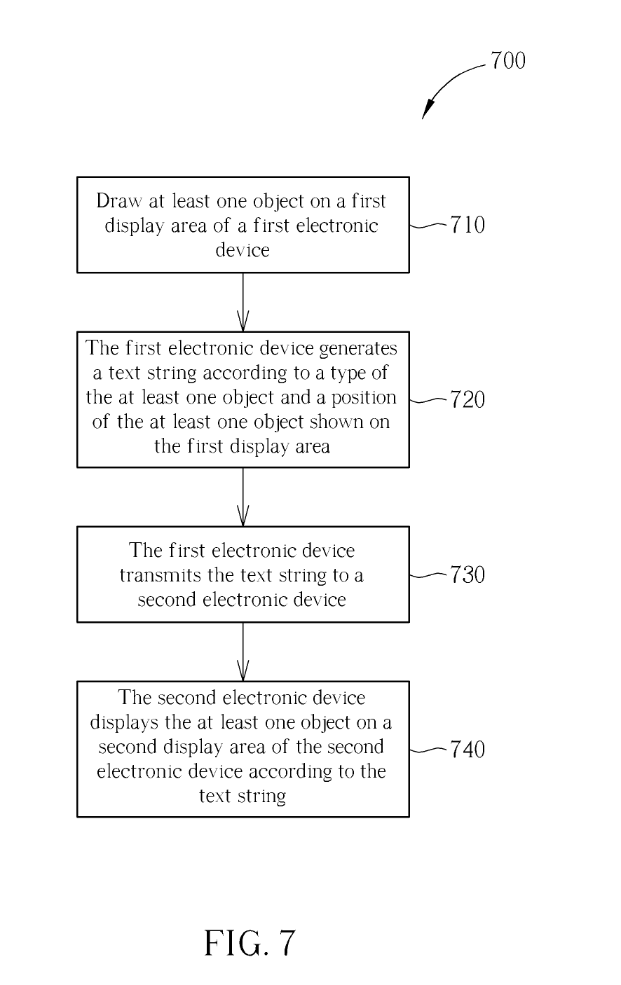

Please refer to FIG. 7. FIG. 7 is a flowchart 700 showing the method for describing characteristics of drawn objects by the text string. The flowchart of the method for describing characteristics of drawn objects by the text string of the present invention comprises the following steps:

Step 710: Draw at least one object on a first display area of a first electronic device;

Step 720: The first electronic device generates a text string according to a type of the at least one object and a position of the at least one object shown on the first display area;

Step 730: The first electronic device transmits the text string to a second electronic device; and

Step 740: The second electronic device displays the at least one object on a second display area of the second electronic device according to the text string.

Basically, the steps of the flowchart 700 need not be in the exact order shown and need not be contiguous, that is, other steps can be inserted between.

In addition, the first electronic device 100 and the second electronic device 200 can be portable electronic devices, such as smart phones or tablet PCs. However, the method of the present invention is not limited to being performed by the portable electronic devices. The method of the present invention can be performed by a desktop computer or other types of electronic devices capable of transmitting short messages or surfing the Internet.

In contrast to the prior art, processes of the method of the present invention are simple and convenient to the user. Moreover, the method of the present invention is capable of converting the drawn objects to the text string or barcode for being transmitted, such that it is time-saving and cost-saving for data transmission.

In addition, the text string can be stored, and the stored text string can be further read by the electronic device to display the drawn objects according to the stored text string.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for describing characteristics of drawn objects by a text string, the method comprising:
drawing at least one object on a first display area of a first electronic device;
the first electronic device generating a text string according to a type of the at least one object and a position of the at least one object shown on the first display area, the text string comprising a description text of the at least one object, and the description text of the at least one object comprising a code of the at least one object and coordinates of the at least one object;
the first electronic device transmitting the text string to a second electronic device; and
the second electronic device displaying the at least one object on a second display area of the second electronic device according to the text string.

2. The method of claim 1, wherein the text string further comprises coordinates of a reference point on the first display area, and the coordinates of the at least one object are relative coordinates corresponding to the reference point.

3. The method of claim 2, wherein the coordinates of the reference point on the first display area are geographical coordinates of the map software.

4. The method of claim 1, wherein the first display area and the second display area are display areas of map software.

5. The method of claim 4, wherein the coordinates of the reference point on the first display area are geographical coordinates of the map software.

6. The method of claim 1, wherein the first electronic device transmitting the text string to the second electronic device is the first electronic device transmitting the text string to the second electronic device by a short message service (SMS).

7. The method of claim 1, further comprising the first electronic device generating a corresponding barcode according to the text string, wherein the first electronic device transmitting the text string to the second electronic device is the first electronic device transmitting the corresponding barcode to the second electronic device.

8. The method of claim 1, wherein the text string is embedded into an Internet address of a webpage; and the second electronic device displaying the at least one object on the second display area of the second electronic device according to the text string is the second electronic device browsing the webpage, and a server of the webpage drawing the at least one object on the webpage according to the text string.

9. The method of claim 1, wherein the code of the at least one object is for representing a point, a line, a polygon, a plane, a 3D object, text, an Internet address, a uniform resource identifier (URI), a symbol, or an equation.

10. The method of claim 9, wherein when the code of the at least one object is for representing a straight line, the coordinates of the at least one object comprise coordinates of a start point and an end point of the straight line.

11. The method of claim 9, wherein when the code of the at least one object is for representing a polygon, the coordinates of the at least one object comprise coordinates of vertexes of the polygon.

12. The method of claim 9, wherein when the code of the at least one object is for representing a plane or a 3D object, the coordinates of the at least one object comprise coordinates of characteristic points of the plane or 3D object.

13. The method of claim 9, wherein when the code of the at least one object is for representing text, the description text of the at least one object further comprises description wording of the text.

14. The method of claim 9, wherein when the code of the at least one object is for representing an Internet address, the description text of the at least one object further comprises description wording of the Internet address.

15. The method of claim 9, wherein when the code of the at least one object is for representing an equation, the description text of the at least one object further comprises description wording of the equation.

16. The method of claim 1, further comprising storing the text string, wherein the second electronic device displaying the at least one object on the second display area of the second electronic device according to the text string is the second electronic device displaying the at least one object on the second display area of the second electronic device according to the text string after the second electronic device reads the stored text string.

17. A method for describing characteristics of drawn objects by a text string, the text string comprising a description text of at least one object, the description text of the at least one object comprising a code of the at least one object and coordinates of the at least one object, the method comprising:
transmitting the text string to an electronic device; and
the electronic device displaying the at least one object on a display area of the electronic device according to the text string.

18. The method of claim 17, wherein the text string further comprises coordinates of a reference point, and the coordinates of the at least one object are relative coordinates corresponding to the reference point.

19. The method of claim 17, further comprising generating a corresponding barcode according to the text string, wherein transmitting the text string to the electronic device is transmitting the corresponding barcode to the electronic device.

20. The method of claim 17, wherein the text string is embedded into an Internet address of a webpage; and the electronic device displaying the at least one object on the display area of the electronic device according to the text string is the electronic device browsing the webpage, and a server of the webpage drawing the at least one object on the webpage according to the text string.

21. The method of claim 17, further comprising the electronic device storing the text string, wherein the electronic device displaying the at least one object on the display area of the electronic device according to the text string is the electronic device displaying the at least one object on the display area of the electronic device according to the text string after the electronic device reads the stored text string.
